(19) United States
(12) Patent Application Publication
(10) Pub. No.: US 2009/0058736 A1
(43) Pub. Date: Mar. 5, 2009

(54) Antenna structure and manufacture method thereof

(76) Inventor: Meng-Chien Chiang, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,879

(22) Filed: Oct. 5, 2007

Related U.S. Application Data
(60) Provisional application No. 60/969,325, filed on Aug. 31, 2007.

(51) Int. Cl. H01Q 1/24

(52) U.S. Cl. 343/702

(57) ABSTRACT

An antenna structure and its manufacture method are disclosed. The antenna structure is applied to an electronic device and wirelessly operated at least a frequency band. The antenna structure includes a first antenna body, a second antenna body connected to the first antenna body through a third body. The first antenna body is provided for generating radiations. The second antenna body is connected to the first antenna body through the third body. The second antenna body has a folding portion upwardly extended from a tail portion of the second antenna body to reflect scattered radiations generated by the first antenna body to increase broadband, and at least two beveled edges are formed at a side of the first antenna body to increase peak gain. The antenna structure is a PIFA antenna, and the folding portion is upwardly extended toward the first antenna body, thereby completely reflecting scattered radiations.

### FIELD OF THE INVENTION

The present invention generally relates to an antenna structure and its manufacture method, and more specifically relates to utilize a folding portion disposed to a grounding plane of a PIFA (planar inverted-F antenna) to reflect scattered radiations, thereby increasing broadband and concentrating the antenna field.

### BACKGROUND OF THE INVENTION

As wireless communication is in widespread use, antennas have become an important element for electronic devices such as computers, personal digital assistants, cell phones and other wireless network equipment to support wireless communication such as GSM (Global System for Mobile Communications, working frequency is between 890 MHz and 960 MHz frequency bands and impedance bandwidth is 7.6), WI-FI, WLAN (wireless local area network) or other wireless standards. Generally, the aforesaid antennas are disposed into the electronic devices, and so called embedded antennas. A planar inverted-F antenna (PIFA) is one of these embedded antennas, and has advantages of great electrical performance, low cost and specific absorption rate (SAR) value. The PIFA antenna given a name is that its side structure is the same as inverted-F letter.

The classical PIFA antenna is composed of a rectangular metal plate taken as radiator, a bigger grounding plane and a short circuit plate. When the radiator of the conventional PIFA antenna transmits signals, radiations may also be outwardly scattered. Most of radiations can be utilized and only few radiations may not be employed, resulting in wastage. Consequently, the antenna field may not be concentrated and performance may be reduced. Another drawback is that when the metal plate as a radiator transmits signals, the antenna gain is usually below 2.5 dBi (decibel), resulting in low efficiency.

To overcome the foregoing shortcomings, the inventor(s) of the present invention based on years of experience in the related field to conduct extensive researches and experiments, and finally invented an antenna structure and its manufacture method as a method or a basis for resolving the foregoing drawbacks.

### SUMMARY OF THE INVENTION

Briefly, it is a first object of the present invention to provide an antenna structure. The antenna structure is applied for an electronic device and wirelessly operated at least frequency band. The antenna structure is composed of a first antenna body, a second antenna body and a third body. The first antenna body is provided for generating radiations, and the second antenna body is connected to the first antenna body through the third body. The second antenna body has a folding portion upwardly extended from a tail portion of the second antenna body, and the folding portion is utilized to reflect scattered radiations generated by the first antenna body to increase broadband.

A second objective of the present invention is to provide a method for manufacturing an antenna structure applied to an electronic device and wirelessly operated at least a frequency band. The method has the following steps:
a). Providing a first antenna body to generate radiations;
b). Utilizing a third body to connect a second antenna body and the first antenna body; and
c). Upwardly extending a folding portion from a tail portion of the second antenna body to reflect scattered radiations generated by the first antenna body to increase broadband.

Since the folding portion is made, scattered radiations can be completely reflected to sufficiently utilize these radiations, thereby concentrating the antenna field and increasing performances.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is a schematic diagram illustrating an antenna structure according to an embodiment of the present invention;

FIG. 2 is a schematic diagram illustrating a PIFA antenna structure mounted to a shielding case of the present invention;

FIG. 3 is a flowchart illustrating a method for manufacturing an antenna structure of the present invention;

FIG. 4 is a curve diagram illustrating return losses generated by a PIFA antenna structure of the present invention; and

FIG. 5A to FIG. 5I are schematic diagrams illustrating antenna patterns of an antenna structure of the present invention.

### DETAILED DESCRIPTION OF THE PREFERRED EMBODIMENTS

Referring to the related figures for the antenna structure and its manufacture method according to a preferred embodiment of the present invention, wherein the same elements are described by the same reference numerals.

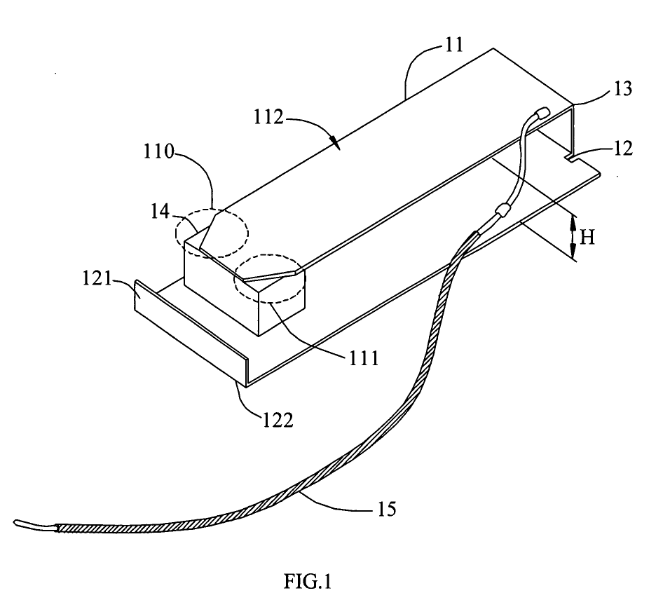

Referring to FIG. 1 for the schematic diagram illustrates an antenna structure according to an embodiment of the present invention. The antenna structure 10 is applied for an electronic device (not shown in the figure) and wirelessly operated at least a frequency band. The antenna structure 10 includes a first antenna body 11, a second antenna body 12 and a third body 13. The first antenna body 11 is provided for generating radiations. The second antenna body 12 is connected to the first antenna body 11 through the third body 13. It should be noted that the second antenna body 12 is parallel the first antenna body 11 to define a height H between the first antenna body 11 and the second antenna body 12. A folding portion 121 is upwardly extended from a tail portion 122 of the second antenna body 12, and can be toward the first antenna body 11 without directly contacting the first antenna body 11. The folding portion 121 is provided for reflecting scattered radiations generated by the first antenna body 11, thereby increasing broadband. Moreover, we cut one corner of the side 112 to form a beveled edge 110 to increase the antenna peak gain. Pursuant to the forward result, we cut another corner of the side 112 to form another beveled edge 111 to increase more the antenna peak gain. A supporting cylinder 14 is further employed to support the first antenna body 11.

In the embodiment, the antenna structure 10 is preferably a PIFA antenna structure, and the frequency band is between 2.4 and 2.5 GHz (gigahertz). The antenna structure 10 is applied for a WLAN conformed to IEEE (Institute of Electrical and Electronic Engineers) 802.11g and IEEE 802.11b. The electronic device can be a computer, a cellular phone, a personal digital assistance (PDA), a router or other electronic equipment equipped with wireless communication capability. The first antenna body 11 is preferably a radiator for transmitting radiations, and the second antenna body 12 is preferably a grounding plane, and the third body 13 is preferably a short circuit plane. The first antenna body 11 has a feed point connected to a feed wire 15. The first antenna body 11 can be designed to form a lambda/4 resonator that generates resonance at ¼-wavelength. The ¼ wavelength is around 3.1 cm, and it should be noted that the wavelength is 12.5 cm when the frequency is at 2.4 GHz.

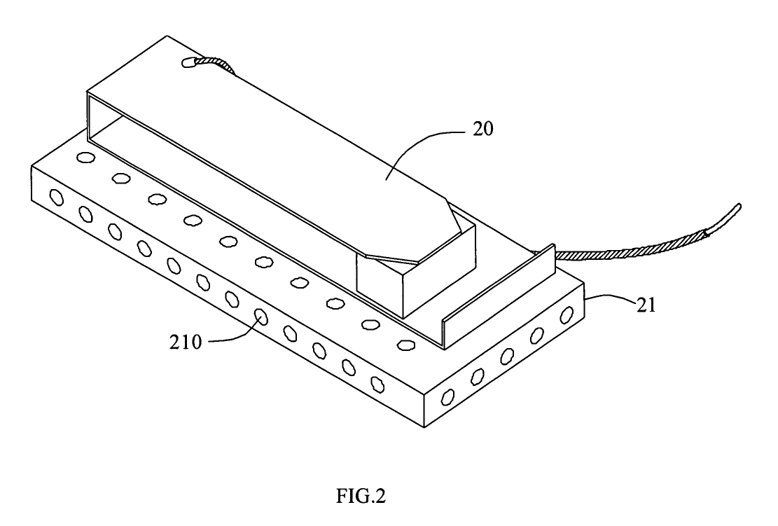

Referring to FIG. 2 for the schematic diagram illustrates a PIFA antenna structure mounted to a shielding case of the present invention. A wireless transistor as a high frequency chip (not shown in the figure) can be disposed inside the shielding case 21. The shielding case 21 has a plurality of air outlets 210 for dissipating heat generated by the transistor. The transistor may not interfere with the PIFA antenna structure 20 through the shielding of the shielding case 21. In another word, the interference generated by the transistor is least when the PIFA antenna structure 20 is disposed onto the shielding case 21. The signal transmission can be smoothly achieved by the PIFA antenna structure 20.

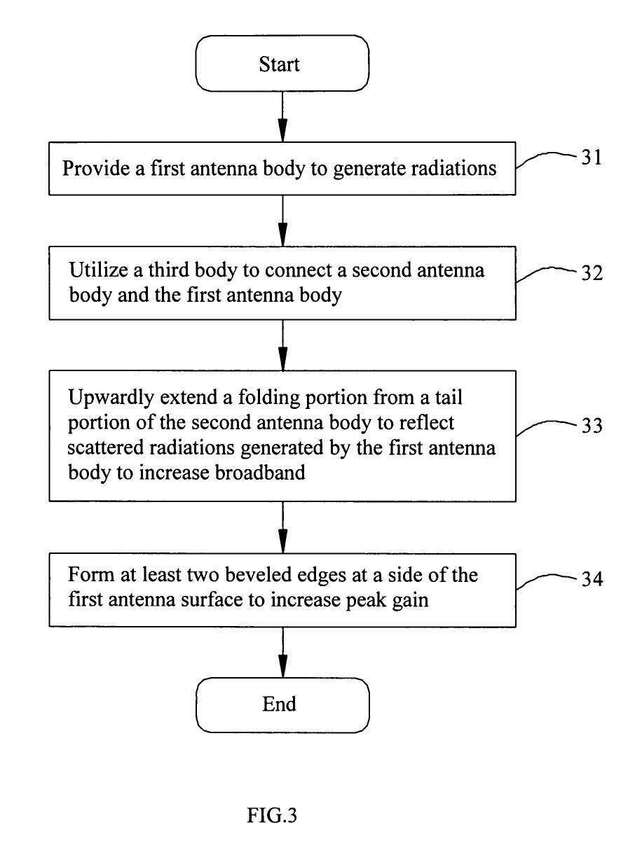

Referring to FIG. 3 for the flowchart illustrates a method for manufacturing an antenna structure of the present invention. The method includes the following steps:

Step 31: Provide a first antenna body to generate radiations;

Step 32: Utilize a third body to connect a second antenna body and the first antenna body;

Step 33: Upwardly extend a folding portion from a tail portion of the second antenna body to reflect scattered radiations generated by the first antenna body to increase broadband; and

Step 34: Form at least two beveled edges at a side of the first antenna body to increase peak gain.

The antenna structure is preferably a PIFA antenna. The first antenna body can be a planar rectangle made of metal, and the second antenna body can be a ground plane, and the third body can be a short circuit metal plate disposed and connected to the planar rectangle and the ground plane. The second antenna body is greater than the first antenna body. It should be noted that the second antenna body is parallel the first antenna body to define a height between the first antenna body and the second antenna body. The folding portion can be toward the first antenna body without directly contacting the first antenna body. Moreover, the first antenna body further has at least two beveled edges by shearing two corners of the first antenna body.

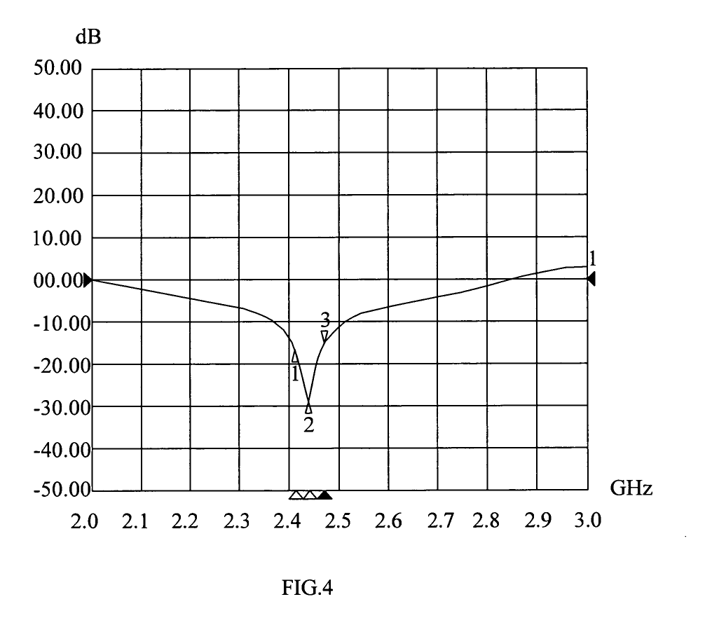

Referring to FIG. 4 for the curve diagram illustrates return losses generated by a PIFA antenna structure of the present invention. The horizontal axis represents frequency, and the longitudinal axis represents return loss. The return loss is measured based on 2.4 GHz frequency. When the value of return loss is more and more small, the reflecting power is smaller. Namely, most of powers can be sent to the PIFA antenna structure. When the frequency is at 2.412 GHz, the return loss is −16.958 dB. When the frequency is at 2.442 GHz, the return loss is −28.831 dB. When the frequency is at 2.472 GHz, the return loss is −15.416 dB. As shown in the diagram, when the frequency is at 2.442 GHz, the reflecting power is smallest.

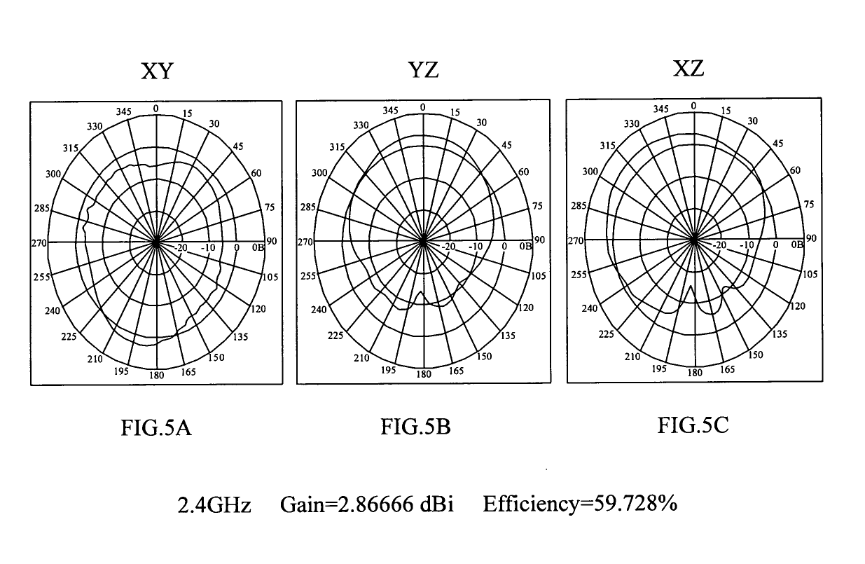

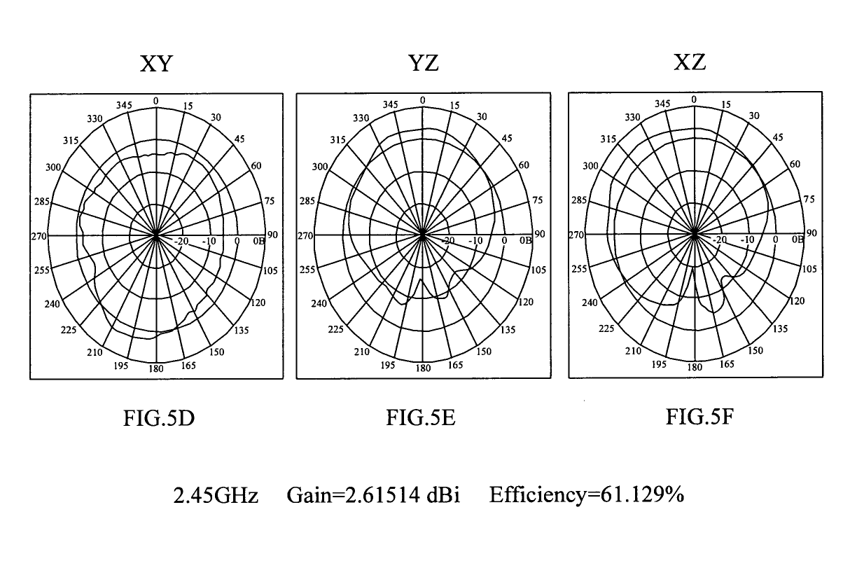

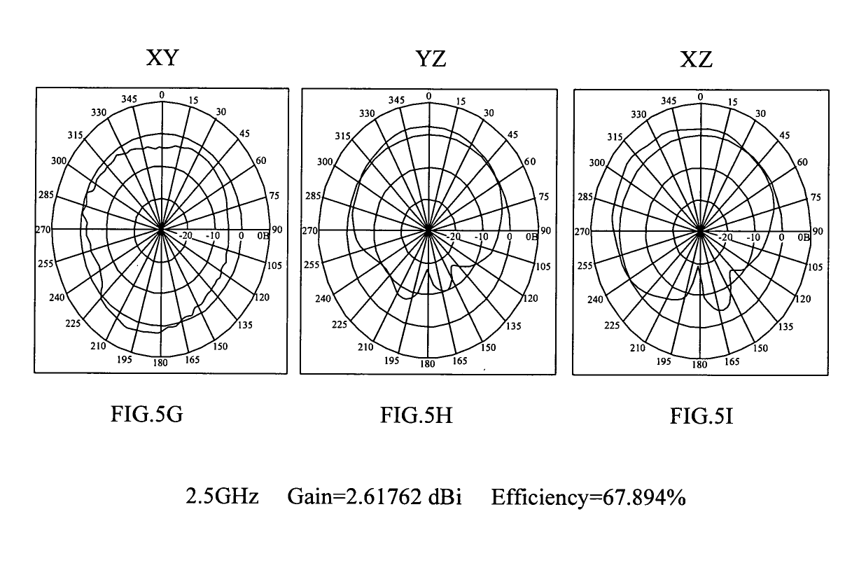

Referring to FIG. 5A to FIG. 5I for the schematic diagrams illustrate antenna patterns of an antenna structure of the present invention. The antenna structure is a PIFA antenna. Since the antenna pattern is an important issue of designing an antenna structure, the antenna gain of the PIFA antenna is greater than 2.5 dBi. The frequency starts at 2.4 GHz, and every frequency shows three planes, including X-Y plane, Y-Z plane and Z-X plane. When the frequency is at 2.4 GHz, the antenna gain is 2.82725 dBi, and efficiency achieves 89.702%. When the frequency is at 2.45 GHz, the antenna gain is 2.8223 dBi, and efficiency achieves 85.884%. When the frequency is at 2.5 GHz, the antenna gain is 2.53953 dBi, and efficiency achieves 90.632%.

While the invention has been described by way of example and in terms of a preferred embodiment, it is to be understood that the invention is not limited thereto. To the contrary, it is intended to cover various frequency and similar arrangements and procedures, and the scope of the appended claims therefore should be accorded the broadest interpretation so as to encompass all other frequency and similar arrangements and procedures.

1. An antenna structure for an electronic device and wirelessly operated at a specific frequency band, comprising:
a first antenna body for generating radiations; and
a second antenna body connected to the first antenna body through a third body, and disposed at a height H from said first antenna body, wherein the second antenna body has a folding portion upwardly extended to a height less H, from a tail portion of the second antenna body, and the folding portion is provided for reflecting scattered radiations generated by the first antenna body to increase broadband.

2. The antenna structure as defined in claim 1, wherein the antenna structure is a PIFA antenna.

3. The antenna structure as defined in claim 1, wherein the frequency band is between 2.4 GHz and 2.5 GHz.

4. The antenna structure as defined in claim 1, wherein the antenna structure is applied for a WLAN conformed to IEEE 802.11 g and IEEE 802.11 b.

5. The antenna structure as defined in claim 1, wherein the electronic device includes a computer, a cellular phone, a personal digital assistance, a router or other electronic equipment equipped with wireless communication capability.

6. The antenna structure as defined in claim 1, wherein the first antenna body is a radiator for transmitting radiations.

7. The antenna structure as defined in claim 1, wherein the second antenna body is a grounding plane.

8. The antenna structure as defined in claim 1, wherein the third body is a short circuit plane.

9. The antenna structure as defined in claim 1, wherein the first antenna body has a feed point connected to a feed wire.

10. The antenna structure as defined in claim 1, wherein the first antenna body is designed to form aλ/4 resonator that generates resonance at ¼-wavelength.

11. The antenna structure as defined in claim 1, wherein the first antenna body further has at least one beveled edge formed at a side of the first antenna body to increase peak gain.

12. A method for manufacturing an antenna structure applied to an electronic device and wirelessly operated at least a frequency band, the method comprising:
providing a first antenna body to generate radiations;
utilizing a third body to connect a second antenna body and the first antenna body; said second body disposed a height H from said first antenna body; and
upwardly extending a folding portion to a height less than H, from a tail portion of the second antenna body to reflect scattered radiations generated by the first antenna body to increase broadband.

13. The method for manufacturing an antenna structure as defined in claim 12, wherein the antenna structure is a PIFA antenna.

14. The method for manufacturing an antenna structure as defined in claim 12, wherein the frequency band is between 2.4 GHz and 2.5 GHz.

15. The method for manufacturing an antenna structure as defined in claim 12, wherein the antenna structure is applied for a WLAN conformed to IEEE 802.11 g and IEEE 802.11 b.

16. The method for manufacturing an antenna structure as defined in claim 12, wherein the first antenna body is a radiator for transmitting radiations.

17. The method for manufacturing an antenna structure as defined in claim 12, wherein the second antenna body is a grounding plane.

18. The method for manufacturing an antenna structure as defined in claim 12, wherein the third body is a short circuit plane.

19. The method for manufacturing an antenna structure as defined in claim 12, wherein the first antenna body is designed to form aλ/4 resonator that generates resonance at ¼-wavelength.

20. The method for manufacturing an antenna structure as defined in claim 12, wherein the first antenna body further has at least one beveled edge formed at a side of the first antenna body to increase peak gain.
